(19) United States
(12) Patent Application Publication
(10) Pub. No.: US 2009/0061212 A1
(43) Pub. Date: Mar. 5, 2009

(54) Reduced Crystallizing Aromatic Nylon

(76) Inventor: Kenneth C. Wurtzel, Bridgeton, NJ (US)

Correspondence Address: BANNER & WITCOFF, LTD., TEN SOUTH WACKER DRIVE, SUITE 3000, CHICAGO, IL, 60606, US

(21) Appl. No.: 12/189,851

(22) Filed: Aug. 12, 2008

Related U.S. Application Data
(60) Provisional application No. 60/968,645, filed on Aug. 29, 2007.

(51) Int. Cl. C08G 69/26; C08K 3/34; B32B 5/16; B32B 27/08

(52) U.S. Cl. 428/331; 525/420; 524/606; 524/445; 524/442; 428/323; 428/412

(57) ABSTRACT

A blend comprising a) at least one aromatic nylon with or without inorganic nano-particles and b) at least one aliphatic/aromatic nylon comprising aromatic groups along the polymer backbone in an amount effective to prevent crystallization of the aromatic nylon. The blend reduces crystallization and resulting haze in multilayered products such as bottles, particularly in multilayered products are subjected to steam autoclave sterilization or retorting.

This application claims priority to Provisional Application 60/968,645, filed Aug. 29, 2008, hereby incorporated by reference in its entirety.

### FIELD OF THE INVENTION

Illustrative aspects of the invention relate to nylons and reducing crystallization thereof.

### BACKGROUND

Currently an aromatic nylon, Mitsubishi MXD6 nylon, is employed as a “sandwiched” layer in a variety of plastic multi-layer rigid packaging to provide excellent gas barrier properties to the package. However, MXD6 nylon will crystallize and become hazy if allowed to cool too slowly. Cooling the MXD6 layer rapidly so that it does not crystallize becomes even more difficult when the MXD6 nylon is used to create a very thick layer in a rigid package, such as to provide the package with further enhanced gas barrier properties,

In packages where the body diameter is greater than the neck diameter such as in blow molded packages, the thickness of the MXD6 layer in the neck region may be the greatest within the structure of the package. This thickness makes it very difficult, if not impossible, to cool rapidly and prevent crystallization and hazing. Although biaxial orientation of the MXD6 layer will reduce the tendency to crystallize, it is problematic where container neck diameters are small or where the container design prevents the ability to biaxially orient the MXD6 layer. Haze may be so great that the neck region of the package becomes opaque. This is undesirable in containers intended to be transparent.

Moreover, phyllosilicates or nano-clays or other nano-sized inorganic particles are often incorporated into the MXD6 nylon to enhance the material's gas barrier properties. However, these particles act as nucleating agents providing initiating sites for crystallization. This causes the MXD6 nylon matrix to rapidly crystallize also resulting in undesirable hazing of thick layers in containers, to the extent that, dependent on thickness, the layers becomes opaque. This is also undesirable in containers intended to be transparent.

In rigid packages intended to be exposed to heat treatments for sterilization or contained product cooking such as steam autoclave sterilization or retorting, it is even more difficult to prevent hazing or opacifying of thick MXD6 nylon or filled MXD6 nylon layers.

There is a need for a MXD6 nylon or filled MXD6 nylon that does not crystallize and become hazy or opaque, particularly during steam autoclave sterilization or retorting.

### SUMMARY

Aspects of the invention are directed to a blend comprising a) at least one aromatic nylon with or without inorganic nano-particles and b) at least one aliphatic/aromatic nylon comprising aromatic groups along the polymer backbone in an amount effective to prevent crystallization of the aromatic nylon.

Another aspect relates to a multilayered structure comprising at least one layer comprising a blend of nylons comprising a) at least one aromatic nylon at least one aromatic nylon with or without inorganic nano-particles and b) at least one aliphatic/aromatic nylon comprising aromatic groups along the polymer backbone in an amount effective to prevent crystallization of the aromatic nylon. In a particular aspect the multilayered structure is subjected to steam autoclave sterilization or retorting

Another aspect relates to a method of reducing crystallization in an aromatic nylon comprising blending a) at least one aromatic nylon at least one aromatic nylon with or without inorganic nano-particles with b) at least one aliphatic/aromatic nylon comprising aromatic groups along the polymer backbone in an amount effective to prevent crystallization of the aromatic nylon.

Another aspect is directed to a method of reducing hazing in a multilayered structure comprising preparing the multilayered structure with a blend of nylons comprising a) at least one aromatic nylon at least one aromatic nylon with or without inorganic nano-particles and b) at least one aliphatic/aromatic nylon comprising aromatic groups along the polymer backbone in an amount effective to prevent crystallization of the aromatic nylon. In a particular aspect the multilayered structure is subjected to steam autoclave sterilization or retorting

Another aspect is directed to a method of reducing hazing in a bottle comprising preparing the bottle with a blend of nylons comprising a) at least one aromatic nylon at least one aromatic nylon with or without inorganic nano-particles and b) at least one aliphatic/aromatic nylon comprising aromatic groups along the polymer backbone in an amount effective to prevent crystallization of the aromatic nylon. In a particular aspect the bottle is subjected to steam autoclave sterilization or retorting

### BRIEF DESCRIPTION OF THE DRAWINGS

FIG. 1 shows % light transmission results of pre-steam sterilization

FIG. 2 shows % light transmission results of post-steam sterilization.

FIG. 3 shows transmission differential results at 400 nm for un-autoclaved and autoclaved polymer samples.

FIG. 4 shows transmission differential results at 500 nm for un-autoclaved and autoclaved polymer samples.

FIG. 5 shows transmission differential results at 600 nm for un-autoclaved and autoclaved polymer samples.

FIG. 6 shows transmission differential results at 700 nm for un-autoclaved and autoclaved polymer samples.

FIG. 7 shows transmission differential results at 800 nm for un-autoclaved and autoclaved polymer samples.

### DETAILED DESCRIPTION

Illustrative aspects of the present invention will be described. These aspects merely provide examples of the invention, and it is needless to say that the aspects can be suitably modified without departing from the gist of the invention.

Aspects of the present invention relate to reducing hazing or opacifying of MXD6 nylon or filled MXD6 nylon layers, particularly thick layers of at least 1 mil (0.001″) and greater, for example 15 mils (0.15″) thick. The thicker the layer, the greater the need for reducing hazing or opacifying of MXD6 nylon or filled MXD6 nylon layers.

MXD6 nylon is produced, for example, by polymerization of MXDA and adipic acid. The resulting resin contains meta-xylylene groups of the following formula:

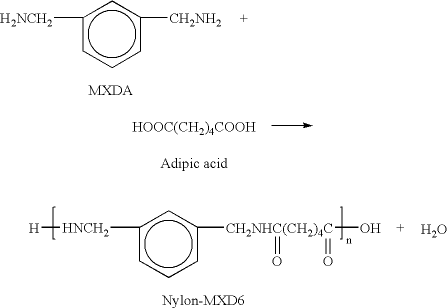

MXD6 nylon crystallizes upon the application of heat such as during steam autoclave sterilization or retorting. Such crystallization produces an undesirable product.

Certain nylons do not crystallize under any normal circumstance and maintain their transparency even in thick sections or when exposed to secondary heat treatment via steam autoclave sterilization or retorting. In addition, they have excellent gas barrier properties that are almost as good as MXD6 nylon, but not as good as MXD6 nylon filled with phyllosilicates or nano-clays or other nano-inorganic particles.

It was discovered that one such nylon material is particularly effective, when combined with MXD6 nylon in reducing crystallization of the MXD6 nylon. This nylon is classified as an aromatic/aliphatic nylon, being polymerized from aromatic and aliphatic monomers and exhibiting aromatic and aliphatic groups along the backbone of the polymer. In particular, the aliphatic/aromatic nylon is classified as a metaxylene diamine/hexamethylene diamine/isophthalic acid nylon. Such an aromatic/aliphatic nylon is available from EMS Chemie as FE7103 and is an amorphous, colorless, transparent, lactam free copolyamide.

It was further discovered that blending the aromatic/aliphatic nylon with MXD6 or MXD6 filled with nano-particles improves the transparency of thick layers. In addition, the use of the aromatic/aliphatic nylon that includes aromatic groups along the polymer backbone improves compatibility with the MXD6 or filled MXD6 material. Importantly, the gas barrier properties of the MXD6 are not sacrificed with the addition of the aromatic/aliphatic nylon.

Typically 15 to 95 wt % of the aromatic/aliphatic nylon is blended with 5 to 85% aromatic nylon such as MXD6 nylon or filled MXD6 nylon. For example, 20 to 60 wt % aromatic/aliphatic nylon can be blended with 40 to 80 wt % aromatic nylon.

The filled aromatic nylon are filled with nano-particles such as, but not limited to, nano-phyllosilicates or nano-clays or other nano-inorganic particles. The amount of nano-particles is generally 1 to 10 wt % of the aromatic nylon, such as 3.5 wt % nanoclay, but can be as high as 25 wt %.

Transparency of thick layers of MXD6 or MXD6 filled with nano-phyllosilicates or nano-clays or nano-inorganic particles is improved and gas barrier properties of the blend is maintained.

Aspects of the invention further include a multilayered structure. At least one layer is prepared from at least one aromatic nylon with or without inorganic nano-particles and at least one aliphatic/aromatic nylon comprising aromatic groups along the polymer backbone in an amount effective to prevent crystallization of the aromatic nylon.

The other layers in the multilayer structure may be any suitable polymer layer. For example polyolefins such as polypropylene, polymethyl pentene, cyclic olefin polymers, cyclic olefin copolymers, or other materials such as, but not limited to, polysulfone, polyaryl sulfone, polyether sulfone, polyethylene terephthalate, polystyrene and polystyrene copolymers, polyacrylonitrile, and polyethylene naphthalate. A further example includes polycarbonate.

The multilayered structure is subject to steam autoclaving or retorting to obtain the final product. Steam sterilization, or steam autoclaving, is used to destroy microbiologicals. Retorting is essentially the same; however, it is terminology generally used in the food packaging or canning industry. It differs from steam sterilization in that retorting cooks the food and, at the same time destroys microbiologicals that are deleterious to the food (color, consistency, flavor, aroma, etc.) or microbiologicals that are pathogenic if ingested. Pressure vessels capable of safely containing and controlling high pressure and temperature steam exposure are employed. These pressure vessels are also called autoclaves or retorts.

Conditions for steam sterilization or retorting are well within the skill of the art. For example, exposure to steam at 250° F. (121° C.) for about 30 minutes or to 270° F. (132° C.) for 3 min can reduce the bacterial population to almost zero. Generally, the higher the temperature, the less time is required. For example, the time-temperature relationship of 12 minutes at 250° F. can have the following equivalents in terms of sterilizing efficiency: 2 minutes at 270° F.; 8 minutes at 257° F.; or 18 minutes at 245° F.

The two factors of moisture and heat should be present for effective sterilization. When moisture is present, bacteria are destroyed at considerably lower temperatures than when moisture is absent. In addition, steam under pressure is used rather than atmospheric steam in order to obtain higher temperatures.

When assessing packaging, typically the starting point is the determination that the package will survive 121° C. (15 psi steam) for 15 minutes.

Further aspects of the invention utilize the multilayered structure in a receptacle such as a bottle. Other uses may be other rigid packaging components such as vials, closures, caps, and lids or non-rigid packaging materials and components, such as film, lidstock, sheeting, bags, pouches and blister packs.

### EXAMPLE

Three layer tensile bars were prepared having the layers polycarbonate/nylon blend/polycarbonate. Each layer was ⅓ of the bar total thickness (0.158 inches). Examples A-G were prepared, each containing a different amounts of the aromatic nylon (nano-clay nylon MXD6 (Imperm 103) and aromatic/aliphatic nylon (FE7103). The percent light at different wavelengths was measured at the gate end of a broad panel for autoclaved samples. The gate end is the end of the molded tensile bar where the gate was located. In injection molding, the gate is the orifice through which molten material is injected to fill the mold cavity. The values provided in the table below are averages of readings on three different samples.

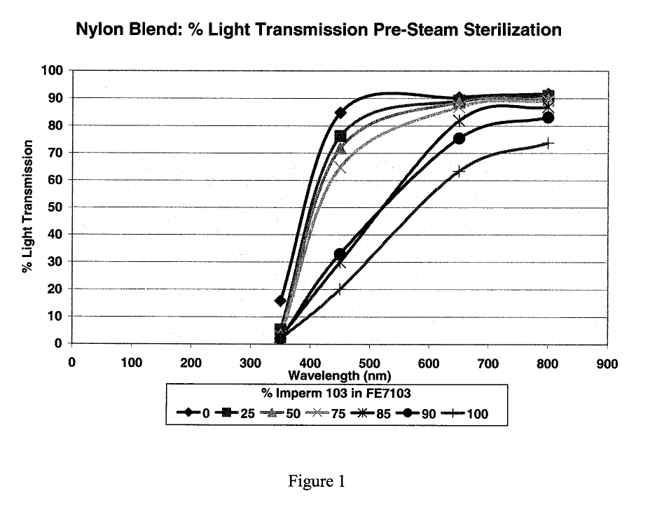

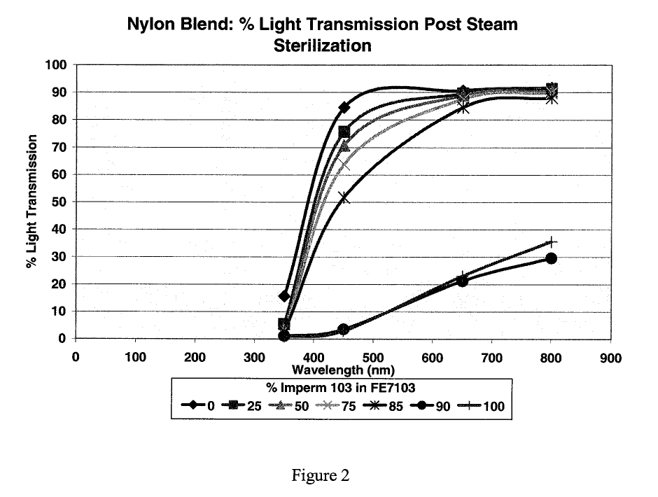

As shown in the table below, the best light transmission was achieved at 100% aliphatic/aromatic nylon although acceptable transmissions occurred as low as about 15% aliphatic/aromatic nylon. Better light transmissions occurred at higher wavelengths. See Table 1 and FIGS. 1 and 2.

TABLE 1

| | % | | | | | |
|---|---|---|---|---|---|---|
| | aromatic/ | | | | | |
| | aliphatic | | | | | |
| | nylon | | | | | |
| | (nanoclay | | % Light Transmission at | | | |
| | nylon | | different wavelengths (nm) | | | |
| Code | MXD6) | | 350 | 450 | 650 | 800 |
| A | 0 | Not | 15.9 | 84.9 | 90.4 | 91.7 |
| | | Autoclaved | | | | |
| | | Autoclaved | 15.7 | 84.6 | 90.7 | 91.7 |
| B | 25 | Not | 5.4 | 76.3 | 89.3 | 91.0 |
| | | Autoclaved | | | | |
| | | Autoclaved | 5.5 | 75.8 | 89.7 | 91.4 |
| C | 50 | Not | 3.6 | 71.8 | 88.7 | 89.8 |
| | | Autoclaved | | | | |
| | | Autoclaved | 3.6 | 70.8 | 89.0 | 90.5 |
| D | 75 | Not | 2.9 | 64.9 | 87.0 | 89.1 |
| | | Autoclaved | | | | |
| | | Autoclaved | 2.6 | 63.9 | 87.6 | 89.9 |
| E | 85 | Not | 2.5 | 30.0 | 82.0 | 87.0 |
| | | Autoclaved | | | | |
| | | Autoclaved | 2.6 | 51.8 | 84.6 | 88.1 |
| F | 95 | Not | 1.9 | 33.0 | 75.5 | 83.2 |
| | | Autoclaved | | | | |
| | | Autoclaved | 1.1 | 3.6 | 21.3 | 29.7 |
| G | 100 | Not | 1.9 | 20.1 | 63.5 | 73.8 |
| | | Autoclaved | | | | |
| | | Autoclaved | 0.9 | 3.0 | 23.1 | 35.7 |

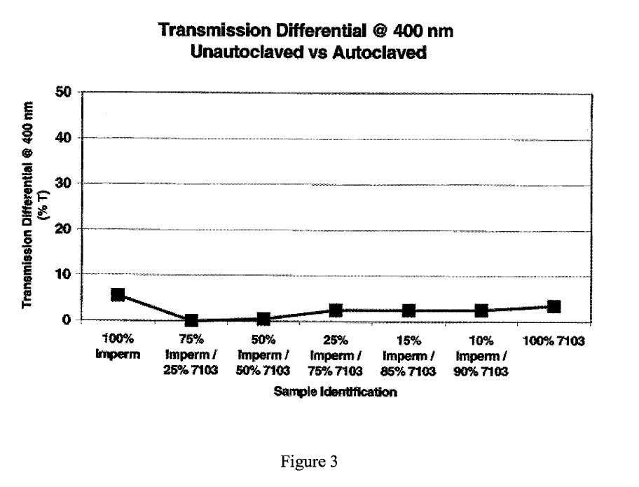

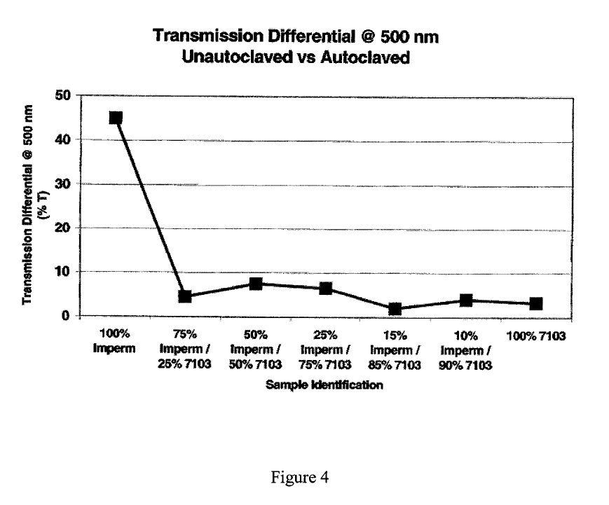

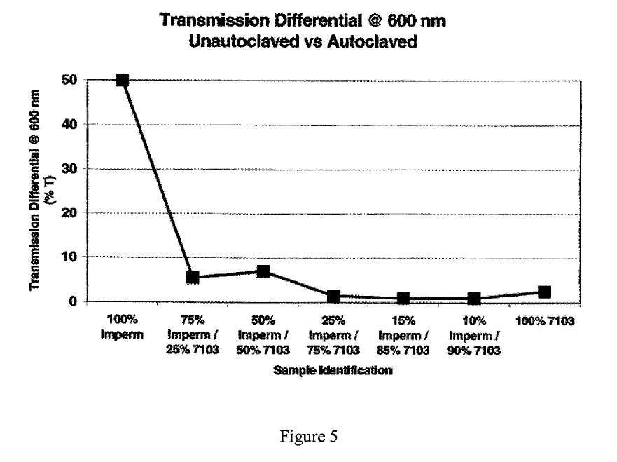

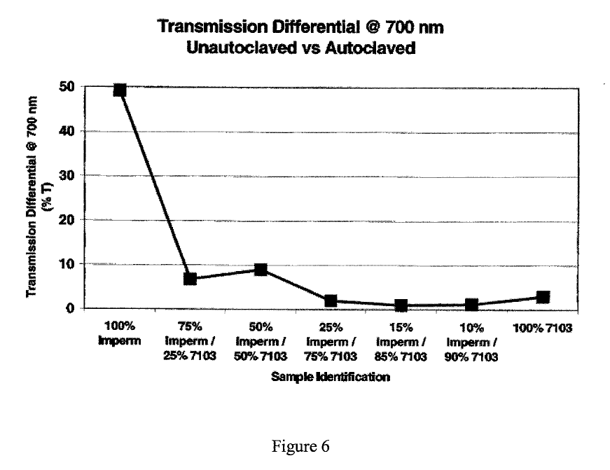

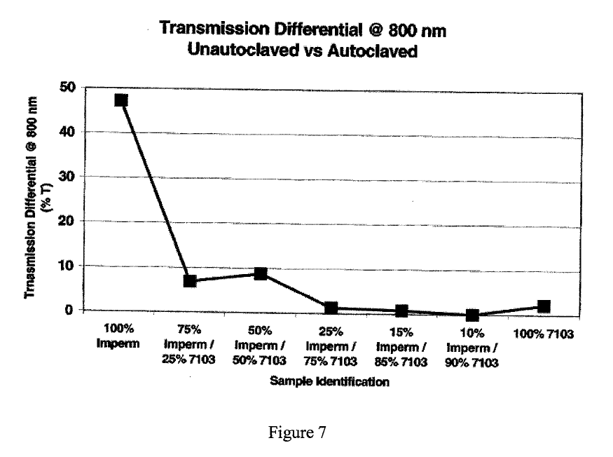

Table 2 shows the difference in light transmission at various wavelengths. This Table demonstrates that one could select a blend ratio to obtain a certain result at various wavelengths. See also FIGS. 3-7.

TABLE 2

| | % aromatic | | | | | | |
|---|---|---|---|---|---|---|---|
| | nylon/ | | | | | | |
| | aliphatic | | % Light Transmission at | | | | |
| | nylon | | different wavelengths (nm) | | | | |
| Code | (FE7103) | | 400 | 500 | 600 | 700 | 800 |
| A | 0 | Not Autoclaved | 7.5 | 58 | 72.5 | 80.2 | 84.2 |
| | | Autoclaved | 2 | 13 | 22.5 | 31 | 37 |
| | | Difference | 5.5 | 45 | 50 | 49.2 | 47.2 |
| B | 25 | Not Autoclaved | 7.5 | 62 | 73.8 | 80.8 | 83.8 |
| | | Autoclaved | 7.5 | 57.5 | 68.3 | 74 | 76.9 |
| | | Difference | 0 | 4.5 | 5.5 | 6.8 | 6.9 |
| C | 50 | Not Autoclaved | 13 | 70.5 | 78 | 82.5 | 84.8 |
| | | Autoclaved | 12.5 | 63 | 71 | 73.5 | 76 |
| | | Difference | 0.5 | 7.5 | 7 | 9 | 8.8 |
| D | 75 | Not Autoclaved | 20 | 76 | 83 | 86 | 87.3 |
| | | Autoclaved | 17.5 | 69.5 | 81.5 | 84 | 86 |
| | | Difference | 2.5 | 6.5 | 1.5 | 2 | 1.3 |
| E | 85 | Not Autoclaved | 21.5 | 76 | 82 | 85 | 86.8 |
| | | Autoclaved | 19 | 74 | 81 | 84 | 86 |
| | | Difference | 2.5 | 2 | 1 | 1 | 0.8 |
| F | 90 | Not Autoclaved | 25 | 78.5 | 84 | 86.7 | 86.9 |
| | | Autoclaved | 22.5 | 74.5 | 83 | 85.5 | 86.9 |
| | | Difference | 2.5 | 4 | 1 | 1.2 | 0 |
| G | 100 | Not Autoclaved | 28.5 | 79.8 | 84.5 | 87.5 | 88.2 |
| | | Autoclaved | 25 | 76.5 | 82 | 84.5 | 86 |
| | | Difference | 3.5 | 3.3 | 2.5 | 3 | 2.2 |

While the various aspects of the invention have been described in conjunction with the example structures and methods described above, various alternatives, modifications, variations, improvements and/or substantial equivalents, whether known or may be presently unforeseen, may become apparent to those having at least ordinary skill in the art. Accordingly, the example structures and methods, as set forth above, are intended to be illustrative of the invention, not limiting it. Various changes may be made without departing from the spirit and scope of the invention. Therefore, the invention is intended to embrace all known or later developed alternatives, modifications, variations, improvements and/or substantial equivalents

What is claimed is:

1. A blend comprising a) at least one aromatic nylon with or without inorganic nano-particles and b) at least one aliphatic/aromatic nylon comprising aromatic groups along the polymer backbone in an amount effective to prevent crystallization of the aromatic nylon.

2. The blend of claim 1 comprising 5 to 85 wt % of the aromatic nylon and 15 to 95 wt % of the aromatic/aliphatic nylon.

3. The blend of claim 1 wherein the at least one aromatic nylon is MXD6 Nylon.

4. The blend of claim 1 wherein the aromatic/aliphatic nylon comprises a backbone having aromatic groups.

5. The blend of claim 1 wherein the aromatic/aliphatic nylon is a metaxylene diamine/hexamethylene diamine/isophthalic acid nylon.

6. The blend of claim 1 wherein the aromatic nylon comprises inorganic nano-particles.

7. The blend of claim 5 wherein the nano-particles are phyllosilicates or nano-clays.

8. A multilayered structure comprising at least one layer comprising a blend of nylons comprising a) at least one aromatic nylon at least one aromatic nylon with or without inorganic nano-particles and b) at least one aliphatic/aromatic nylon comprising aromatic groups along the polymer backbone in an amount effective to prevent crystallization of the aromatic nylon.

9. The multilayered structure of claim 8 wherein the blend comprises 5 to 85 wt % of the aromatic nylon and 15 to 95 wt % of the aromatic/aliphatic nylon.

10. The multilayered structure of claim 8 wherein the at least one aromatic nylon is MXD6 Nylon.

11. The multilayered structure of claim 8 wherein the aromatic/aliphatic nylon comprises a backbone having aromatic groups.

12. The multilayered structure of claim 8 further comprises inorganic nano-particles.

13. The multilayered structure of claim 8 wherein the nano-particles are phyllosilicates or nano-clays.

14. The multilayered structure of claim 8 wherein the aromatic/aliphatic nylon is a metaxylene diamine/hexamethylene diamine/isophthalic acid nylon.

15. The multilayered structure of claim 8 further comprising at least one polycarbonate layer.

16. The multilayered structure of claim 8 wherein the multilayered structure is heat treated by steam autoclave sterilization or retorting.

17. A rigid packaging material comprising the multilayered structure of claim 7.

18. A method of reducing crystallization in an aromatic nylon comprising blending a) at least one aromatic nylon at least one aromatic nylon with or without inorganic nano-particles with b) at least one aliphatic/aromatic nylon comprising aromatic groups along the polymer backbone in an amount effective to prevent crystallization of the aromatic nylon.

19. A method of preparing a rigid multi-layer packaging material comprising preparing at least one layer by blending a) at least one aromatic nylon at least one aromatic nylon with or without inorganic nano-particles with b) at least one aliphatic/aromatic nylon comprising aromatic groups along the polymer backbone in an amount effective to prevent crystallization of the aromatic nylon; and forming the rigid multi-layer packaging material.

20. The method of claim 19 further comprising heat treating the rigid multi-layer packaging material by steam autoclave sterilization or retorting.

21. A method of reducing hazing in a bottle comprising preparing the bottle with a blend of nylons comprising a) at least one aromatic nylon at least one aromatic nylon with or without inorganic nano-particles and b) at least one aliphatic/aromatic nylon comprising aromatic groups along the polymer backbone in an amount effective to prevent crystallization of the aromatic nylon.

22. The method of claim 21 further comprising heat treating the rigid multi-layer packaging material by autoclave sterilization or retorting.
